(19) United States
(12) Patent Application Publication
(10) Pub. No.: US 2025/0310663 A1
(43) Pub. Date: Oct. 2, 2025

(54) VEHICULAR SENSING SYSTEM

(71) Applicant: Magna Electronics Inc., Auburn Hills, MI (US)

(72) Inventors: Jens Steigerwald, Sailauf-Eichenberg (DE); Benjamin Peter, Goldbach (DE)

(21) Appl. No.: 19/093,335

(22) Filed: Mar. 28, 2025

Related U.S. Application Data
(60) Provisional application No. 63/572,428, filed on Apr. 1, 2024.
(60) Provisional application No. 63/632,151, filed on Apr. 10, 2024.
(60) Provisional application No. 63/747,459, filed on Jan. 21, 2025.

(51) Int. Cl. H04N 25/709; G01S 7/03; H04N 23/57

(52) U.S. Cl. CPC H04N 25/709; H04N 23/57; G01S 7/03

(57) ABSTRACT

A vehicular sensing system includes a sensor disposed at a vehicle and sensing exterior of the vehicle. The sensor is operable to capture sensor data. An electronic control unit (ECU) includes electronic circuitry and associated software, with the electronic circuitry of the ECU including a data processor operable to process sensor data captured by the sensor and transferred to the ECU. The sensor connects with the ECU via a cable. The sensor is electrically powered by a power source, and the electrical power from the power source is not provided to the sensor via the cable. The cable carries an enable signal from the ECU to the sensor. T\Responsive to the sensor receiving the enable signal from the ECU, sensor data captured by the sensor is transferred to the ECU via the cable.

### CROSS REFERENCE TO RELATED APPLICATIONS

The present application claims the filing benefits of U.S. provisional application Ser. No. 63/747,459, filed Jan. 21, 2025, U.S. provisional application Ser. No. 63/632,151, filed Apr. 10, 2024, and U.S. provisional application Ser. No. 63/572,428, filed Apr. 1, 2024, which are hereby incorporated herein by reference in their entireties.

### FIELD OF THE INVENTION

The present invention relates generally to a vehicle sensing system for a vehicle and, more particularly, to a vehicle sensing system that utilizes one or more sensors such as one or more cameras, radar sensors, etc., at a vehicle.

### BACKGROUND OF THE INVENTION

Use of sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A vehicular sensing system includes a sensor disposed at a vehicle equipped with the vehicular sensing system and sensing exterior of the equipped vehicle. The sensor is operable to capture sensor data. The system includes an electronic control unit (ECU) with electronic circuitry and associated software. The electronic circuitry of the ECU includes a data processor operable to process sensor data captured by the sensor and transferred to the ECU. The sensor connects with the ECU via a cable. The sensor is electrically powered by a power source, and electrical power from the power source is not provided to the sensor via the cable. The cable carries sensor data captured by the sensor from the sensor to the ECU and the cable carries an enable signal from the ECU to the sensor. The sensor, responsive to receiving the enable signal from the ECU, transfers sensor data captured by the sensor to the ECU.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a sensor system that incorporates sensors;

FIG. 2 is a schematic view of an electronic control unit (ECU) and a camera;

FIG. 3A is a schematic view of a camera operable to receive an enable over coaxial signal;

FIG. 3B is a schematic view of an ECU operable to provide an enable over coaxial signal;

FIG. 4 is a schematic view of an ECU and a camera connected with a coaxial cable for an enable over coaxial signal;

FIG. 5 is a schematic view of a camera with a power management integrated circuit;

FIG. 6 is a schematic view of an ECU with a power management integrated circuit;

FIG. 7 is a schematic view of a camera with an integrated switch;

FIG. 8A is a schematic view of a camera isolated from an ECU via galvanic isolation;

FIG. 8B is a schematic view of a test circuit;

FIG. 9 is a schematic view of multiple cameras each connected to an ECU via separate cables; and

FIG. 10 is a schematic view of a camera with a watchdog circuit.

### DESCRIPTION OF THE PREFERRED EMBODIMENTS

A vehicle sensing system and/or vision system and/or driver or driving assist system and/or object detection system and/or alert system operates to capture sensor data (e.g., images) exterior of the vehicle and may process the captured sensor data to display images and/or to detect objects at or near the vehicle and in the predicted path of the vehicle, such as to assist a driver of the vehicle in maneuvering the vehicle in a rearward direction. The sensing system includes a data processor or data processing system that is operable to receive sensor data from one or more sensors and optionally provide an output to a display device for displaying images representative of the captured sensor data. Optionally, the sensing system may provide a display, such as a rearview display or a top down or bird's eye or surround view display or the like.

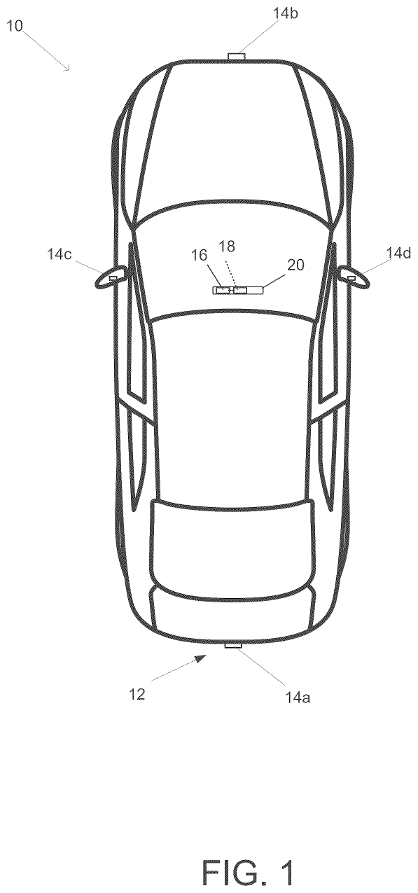

Referring now to the drawings and the illustrative embodiments depicted therein, a vehicle 10 includes a sensing system or vision system 12 that includes at least one exterior viewing imaging sensor or camera, such as a rear backup camera or rearward viewing imaging sensor or camera 14a (and the system may optionally include multiple exterior viewing imaging sensors or cameras, such as a forward viewing camera 14b at the front (or at the windshield) of the vehicle, and a sideward/rearward viewing camera 14c, 14d at respective sides of the vehicle), which captures images exterior of the vehicle, with the camera having a lens for focusing images at or onto an imaging array or imaging plane or imager of the camera (FIG. 1). Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The system may include one or more interior sensors, such as an interior viewing camera for a driver and/or occupant monitoring system. The system may additionally or alternatively include a number of other sensors or systems, such as radar sensors, lidar, ultrasonic sensors, GPS sensors, etc. The sensing system 12 includes a control or electronic control unit (ECU) 18 having electronic circuitry and associated software, with the electronic circuitry including a data processor or image processor that is operable to process image data captured by the camera or cameras, whereby the ECU may detect or determine presence of objects or the like and/or the system provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

The camera or cameras may connect to the ECU via a respective cable or respective cables, such as coaxial cables or the like. For example, the cameras may connect to the ECU via coaxial cables, such as by utilizing aspects of the systems described in U.S. Pat. Nos. 10,567,705; 10,154,185; 10,071,687; 9,900,490 and/or 9,036,026, which are hereby incorporated herein by reference in their entireties.

Power over coaxial allows automotive designers to reduce vehicle weight by sending power and data over the same cable. In some implementations, it may be advantageous to power the ECU, the camera (or other sensor), and/or an associated SERDES (serializer/deserializer) device directly from a main power supply (e.g., a vehicle battery, direct Vbatt connection, clamp 15 connection, clamp 30 connection, etc.), while powering microcontrollers, microprocessors, and/or other integrated circuits and electronic components associated with the camera via a separate power supply (i.e., indirectly from the main power supply). A clamp 15 connection refers to a connection point in the vehicle's electrical system that is energized when the ignition is in the “run” or “accessory” position, and a clamp 30 connection refers to a connection point that is always energized, directly connected to the battery positive terminal. The term “Vbatt” is commonly used in automotive electrical contexts to denote the battery voltage. In some examples, the other electronic components associated with the camera may be powered by a power management integrated circuit (PMIC). A PMIC is an integrated circuit that manages power requirements of a host system. The PMIC may be responsible for a variety of functions such as voltage regulation, DC-DC conversion, battery charging, power source selection, and power sequencing. The other electronic components that may be powered by the PMIC include, but are not limited to, an imager of the camera, an image signal processor (ISP), memory (e.g., EEPROM, flash, etc.), a microcontroller unit (MCU) associated with camera, light emitting diodes (LEDs), and/or other supporting circuitry.

In such implementations, the camera may be enabled (i.e., “woken up”) via a SERDES reverse channel. The SERDES reverse channel, also known as a back channel or control channel, is a low-speed communication channel that operates in the opposite direction of the high-speed data transmission. Such a channel is typically used for control signals, configuration data, and status information exchange between the serializer and deserializer. The reverse channel allows for bidirectional communication, even when the primary data flow is unidirectional. Similarly, the camera and the serializer may be disabled (i.e., “put into sleep mode”) via the ECU or automatically in the event of a fault, such as when the camera receives no bus communications for several seconds. The disabling may be performed by sending a specific command or signal over the reverse channel or by cutting off the power supply to the relevant components. Alternatively, a time-out mechanism within the camera's internal circuitry may initiate the sleep mode if no communication is detected within a predetermined period, acting as a fail-safe. This predetermined period can be, for example, 1 second, 3 seconds, 5 seconds, 10 seconds or other appropriate duration.

Accordingly, powering only the ECU, the camera, and the SERDES via the power supply may reduce power consumption by minimizing current draw of the components associated with the camera. By selectively powering only the essential components for image acquisition and transmission, the overall system power efficiency is improved. Furthermore, selectively de-powering other circuits reduces their contribution to the overall electromagnetic radiation of the system, enhancing electromagnetic compatibility (EMC). Optionally, different components may have different voltage requirements. For example, the image sensor may operate at a lower voltage than the SERDES device. In such cases, separate power rails and appropriate voltage regulators may be implemented for different components or sets of components, further optimizing power delivery and management.

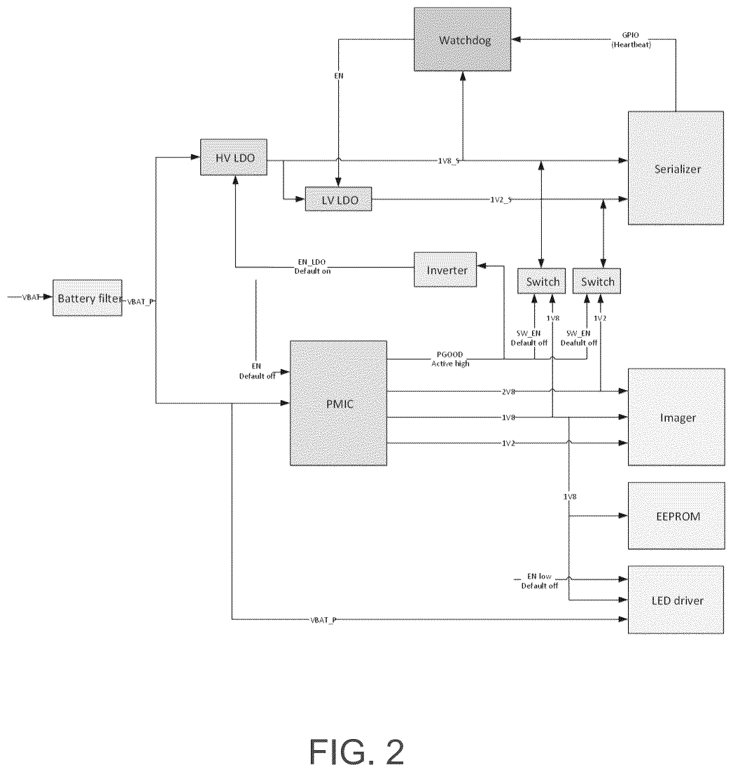

Referring now to FIG. 2, powering the camera and serializer directly from the power supply optionally includes additional electrical components. For example, the serializer may include a separate power supply when the camera is in sleep mode, such as a regulated power supply. Accordingly, low voltage dropout regulators (LDOs), such as a high voltage LDO and a low voltage LDO, may provide a regulated power supply to the serializer during sleep mode. The high voltage LDO may be configured to handle the higher voltage levels typically associated with the vehicle's main power supply (e.g., 12V, 24V, or 48V systems), while the low voltage LDO may be used to provide a lower, regulated voltage suitable for the serializer's operation (e.g., 1.8V, 2.5V, or 3.3V). The selection of specific LDOs will depend on the voltage and current requirements of the serializer and the overall system design.

Power supplied to other components of the camera (e.g., an imager of the camera) may be separated from the power supply to the serializer via switches (e.g., MOSFETs) when the camera is in sleep mode in order to minimize power consumption. These MOSFETs act as electronically controlled switches, isolating the power rails and preventing current leakage to the deactivated components. Other types of switches, such as bipolar junction transistors (BJTs) or solid-state relays, could alternatively be used, depending on the specific design requirements such as switching speed, current handling capacity, and on-state resistance. Additionally or alternatively, components such as an LED driver of the camera may enter a reset or standby mode. The reset mode may place the LED driver in a known, low-power state, while the standby mode may allow for a faster wake-up time compared to a full power-down. The choice between reset and standby modes may depend on the trade-off between power saving and response time.

When the camera is enabled, a PMIC may disable the LDOs and provide power to the other components (e.g., the imager, memory associated with the camera, the LED driver, etc.). The PMIC may act as a central power management hub, distributing power to the various components based on the operational state of the camera. The PMIC may receive the enable signal directly or indirectly, and its response may be programmed to follow a specific power-up sequence to ensure proper operation of all components. Alternatively, instead of completely disabling the LDOs, the PMIC may bypass the LDOs, such as by using integrated switches within the PMIC to route power directly from the main power supply to the other components, thereby providing a more efficient power delivery path when the camera is active. In some examples, upon receiving the enable signal, other circuitry (instead of or in addition to the PMIC) may perform these functions, such as a separate dedicated integrated circuit.

Additional circuitry may also be included to prevent damage to components of the camera that may occur under various failure modes. In one example, if the serializer is not in sleep mode when the ECU provides the enable signal to the serializer, the LDOs providing regulated power to the serializer may be damaged. Accordingly, an inverter circuit may transition the serializer to receive power from the PMIC. For instance, the inverter circuit may include a logic gate (such as a NOT gate or an arrangement of transistors configured to perform a logical inversion) that inverts the enable signal. This inverted signal can then be used to control a switch (e.g., a MOSFET, BJT, or solid-state relay) that disconnects the LDOs from the serializer and connects the serializer to the PMIC's power output. The inverter circuit may be powered by the PMIC when the camera is enabled or by one of the LDOs when the camera is in a sleep state.

In another example, the ECU may experience a fault or a loss of communication with the camera, preventing the ECU from disabling the serializer. Therefore, an alternative means of disabling the serializer may be included. In some examples, a watchdog circuit may monitor for communication loss between the ECU and the camera. The watchdog circuit may be a timer circuit that is periodically reset by a heartbeat signal from the ECU. If the heartbeat signal is not received within a predetermined time period (e.g., 1 second, 3 seconds, 5 seconds, 10 seconds, or any other appropriate duration), the watchdog circuit triggers a reset signal.

In other examples, where the serializer cannot provide a heartbeat input to the watchdog circuit, or where the serializer requires input from an integrated circuit (e.g., a microcontroller) to enter sleep mode, an additional microcontroller may be included to disable the serializer. This microcontroller may receive power from the PMIC when the camera is active and from one of the LDOs (such as the high voltage LDO or low voltage LDO) when the camera is in sleep mode, or, alternatively, the microcontroller has its own independent, low-power supply. The microcontroller may communicate with the serializer via a serial interface (e.g., 12C, SPI) or other suitable communication protocol. The watchdog circuit may receive power from the PMIC when the camera is enabled and can be switched off when the camera is in sleep mode. In sleep mode, the watchdog circuit may receive power from at least one of the LDOs, or the watchdog circuit may be turned off. Alternatively, the watchdog circuit may have its own dedicated low-power LDO or other power source to ensure its operation even when the camera is in a deep sleep mode.

Some implementations herein provide an enable or sleep command or signal over a cable (e.g., a coaxial cable) by generating a signal (e.g., a static DC signal or DC bias or DC offset) with appropriate filtering to provide a low or high state over the coaxial cable to keep a device awake/enabled (e.g. a vehicular camera, such as a rear backup camera 14a, a forward viewing camera 14b, a sideward/rearward viewing camera 14c, 14d, and/or an interior viewing camera for a driver or occupant monitoring system). The static signal may be 1 volt, 2 volts, 5 volts, 10 volts, etc. The magnitude of the static signal may be selected to be distinguishable from noise and other signal variations on the coaxial cable, while also minimizing power consumption. The specific voltage level may be determined based on the characteristics of the SERDES interface, the cable length, and the expected electromagnetic interference (EMI) environment. Alternative voltage levels, such as 3.3 volts or 12 volts, may also be used depending on the system's power supply architecture. The filter devices may be small and inexpensive as just a few milliamps of current may be used to establish a stable signal. The filter devices may include passive components, such as inductors and capacitors, arranged in configurations like low-pass filters, high-pass filters, or band-pass filters, to separate the DC enable/sleep signal from the high-frequency data signals. Active filtering techniques, employing operational amplifiers or other active components, may be used for more precise signal separation when required. The filter design may incorporate impedance matching to minimize signal reflections and maximize power transfer efficiency on the coaxial cable. The ground connection to the camera may use galvanic isolation to reduce conducted emission to the cable. Galvanic isolation can be achieved using transformers, optocouplers, or capacitive coupling. This isolation prevents ground loops and reduces common-mode noise, thus improving signal integrity and reducing the risk of interference with other vehicle systems. The type of galvanic isolation may be selected based on the data rate, voltage levels, and safety requirements of the specific application.

This “enable over coaxial” or “sleep over coaxial” may be used to remotely enable/disable switching functions. For instance, the enable/sleep signal can control the on/off state of a power switch (e.g., a MOSFET, BJT, or solid-state relay) that connects the camera's power supply to its internal circuitry, or it can control a PMIC to manage power distribution to different components within the camera. Additionally, the enable over coaxial may replace conventional logical circuit blocks, which tend to be expensive. For example, the enable over coaxial may replace the PMIC, a watchdog circuit, switches, and/or other software logic that may be used to conventionally enable/disable a remote device (e.g., a camera) when connected with a low voltage differential signaling (LVDS) SERDES (serializer/deserializer) device or a current-mode logic (CML) device and to the vehicle battery (i.e., instead of using power over coaxial). This is because the enable/sleep signal directly controls the power state of the remote device, eliminating the need for complex control sequences or dedicated communication protocols. This approach simplifies the system design, reduces component count, and lowers overall cost.

In order to disable the camera in the event of a fault in communication between the ECU and the camera, components associated with the ECU (and not the camera) may perform fault monitoring. For example, the ECU may include line fault monitoring (LFM) via a voltage divider or a watchdog circuit. The voltage divider can be used to monitor the voltage level on the coaxial cable, and a deviation from the expected voltage range can indicate a fault, such as a short circuit or open circuit. A comparator circuit can be used to compare the divided voltage with a predetermined threshold to trigger a fault signal. The watchdog circuit can be used to monitor the presence of the enable/sleep signal or data communication, and a timeout can indicate a communication failure, initiating a transition to a safe state (e.g. disabling the camera). The LFM may provide an input to a microcontroller, such as a general purpose input/output (GPIO), to alert the microcontroller of the fault. The microcontroller may be configured to disable the camera, or other remote sensor, via the enable over coaxial cable in the event of a fault.

The enable over coaxial signal may be transmitted along the coaxial cable using, for example, a DC offset voltage. For example, the ECU may inject a DC voltage offset or bias of a certain threshold for an enable signal and the ECU may inject a different DC voltage offset (or no offset at all) for a disable signal. The threshold for the enable signal may be selected to be high enough to avoid false triggering due to noise or other signal variations, while low enough to minimize power consumption. For instance, the enable signal threshold might be set at 2 volts, 3.3 volts, 5 volts, or any other suitable voltage level, depending on the specific system requirements and the characteristics of the coaxial cable and associated circuitry. The disable signal, in contrast, may be represented by a DC offset of 0 volts, or a voltage level significantly below the enable threshold, such as less than 1 volt, 0.5 volts or less. The camera and ECU may use simple and inexpensive filtering techniques, as discussed in more detail below, to separate the DC offset from the high-speed data (e.g., image data, control data, etc.) simultaneously passed along the coaxial cable.

The enable over coaxial signal may be used in implementations where the ECU and the camera communicate via a Gigabit Monitoring Serial Link (GMSL). In such cases, the GMSL serializer at the ECU may be configured to superimpose the DC offset onto the high-speed data stream, and the GMSL deserializer at the camera may be configured to extract the DC offset. This can be achieved by incorporating appropriate filtering and biasing circuitry within the serializer and deserializer. Furthermore, the enable/disable signal may be compatible with other serial communication protocols, such as FPD-Link (Flat Panel Display Link), or other high-speed serial communication standards used in automotive applications. The principles of using a DC offset to convey an enable/disable signal can be adapted to various communication protocols by appropriately designing the filtering and biasing circuits to match the specific signal characteristics of each protocol. The choice of protocol may depend on factors such as bandwidth requirements, cable length, electromagnetic compatibility (EMC) considerations, and cost.

Thus, implementations herein use a connection from, for example, the main ECU of the vehicle, to a vehicular camera to enable or disable the power supply (e.g., the main power supply, direct Vbatt connection, etc.) for the camera or other sensor. In some examples, a switch (e.g., a MOSFET) may be operable to connect the power supply to the camera. The camera may be an exterior viewing camera for an object detection system or an interior viewing camera for a driver monitoring system and/or occupant monitoring system. This provides the opportunity to remotely enable and disable vehicular cameras or any other remote device connected with LVDS (SERDES over coaxial) connected locally to a battery supply. That is, for devices (e.g., cameras, radar sensors, lidar, etc.) that do not use power over coaxial (and instead have, for example, a direct connection to the battery of the vehicle), the coaxial cable may be used to transfer an enable/disable signal independently and simultaneously with SERDES data. Due to a low current requirement for the enable signal, small and inexpensive filter devices are all that is required to extract the enable signal from the SERDES data. Optionally, line fault circuitry may be included. Additional filtering (e.g., a power over coaxial filter) may be included based on design parameters.

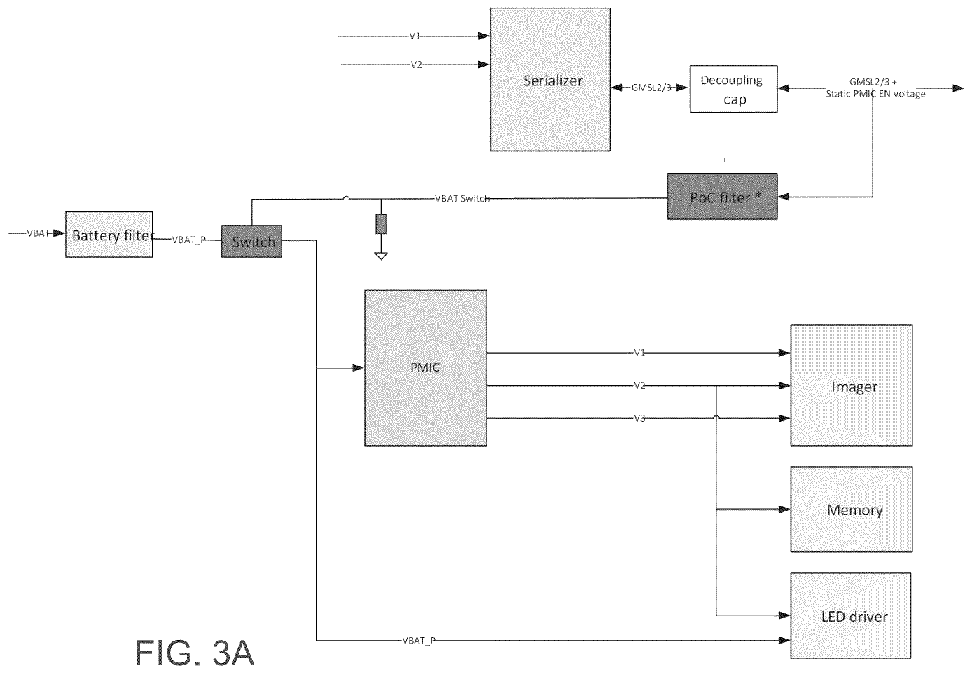

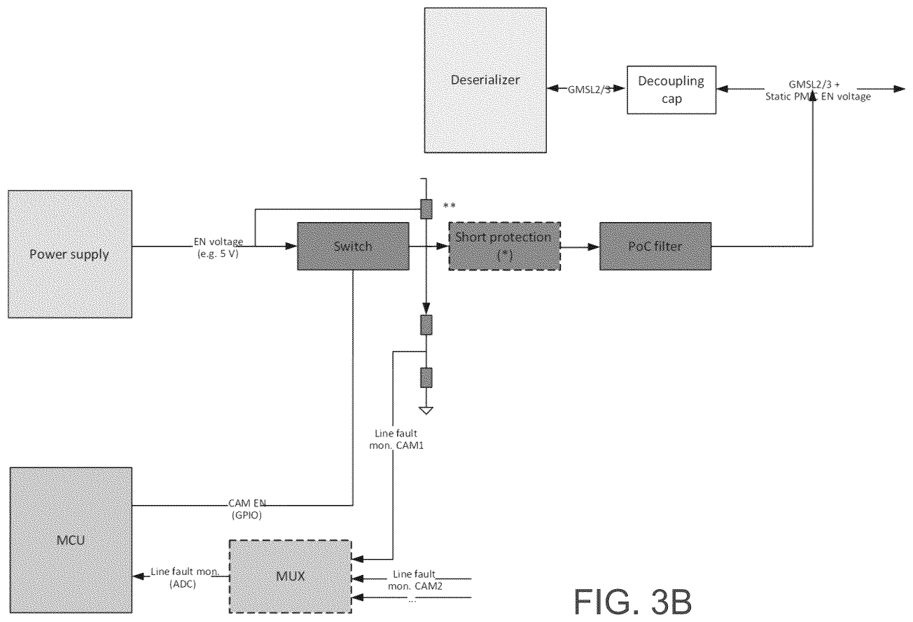

FIG. 3A illustrates a camera (or other source device, such as a radar sensor or the like) operable to receive an enable signal from the ECU over a coaxial cable. In some examples, the camera may be connected to the ECU via a GMSL. A power over coaxial (PoC) filter of the camera may filter out high frequency signals associated with SERDES data as well as reverse channel data. For example, a filtering technique may involve passive components, such as inductors and capacitors, configured as low-pass filters to pass the DC offset while attenuating the high-frequency data signals. For example, as shown in FIGS. 3A and 3B, a Power over Coaxial (PoC) filter may be implemented using a combination of inductors and capacitors. The inductors may be chosen to have high impedance at the data signal frequencies, effectively blocking them, while presenting low impedance to the DC offset. The capacitors may be selected to have low impedance at the data signal frequencies, shunting them to ground, while presenting high impedance to the DC offset. The specific values of the inductors and capacitors may be determined based on the frequency characteristics of the data signals and the desired level of separation between the data and the DC offset. Alternatively, active filter circuits, using operational amplifiers or other active components, can provide greater control of frequency such that they may be employed, although the passive filtering methods tend to provide advantages related to cost and power consumption. Accordingly, the PoC filter passes only a low frequency signal associated with the enable signal. A decoupling capacitor may filter out low frequency signals, such that the capacitor passes only high frequency SERDES data to the serializer.

The ECU may provide the enable signal to the camera by applying a static DC voltage (i.e., a DC bias) to the coaxial cable. A battery switch may be enabled by the static DC voltage on the coaxial cable. The battery switch may be a solid-state switch, a transistor, a solid-state relay, etc. The choice of switch may depend on factors such as the current requirements, switching speed, and on-state resistance. When enabled, the switch connects the power supply (e.g., the main power supply, or vehicle battery) to a PMIC that powers components associated with the camera, such as the imager, memory, and LED driver. The PMIC may regulate and distribute power to these components, providing different voltage rails as needed. For example, the imager may require a lower voltage (e.g., 1.2V or 1.8V) than the serializer (e.g., 3.3V). The PMIC may also include power sequencing logic to ensure that the components are powered up in the correct order, preventing potential damage or malfunction. The LED Driver may be for illuminating LEDs associated with the camera for, for example, infrared night vision or status indication, and the memory may be for buffering image data or storing camera settings.

The battery switch may be enabled with low current to minimize power consumption and minimize leakage current. Low current in this context may refer to a current in the microampere (μA) or milliampere (mA) range, significantly less than the operating current of the camera, which might be in the hundreds of milliamperes or even amperes range. This low enable current minimizes the power drawn from the battery when the camera is in a standby or sleep mode. In some examples, reverse polarity protection may be used in combination with the battery switch. Optionally, LFM may be used to ensure the camera is disabled if communication is lost between the camera and the ECU. For example, a pull-down resistor between the PoC filter and the battery switch of the camera may cause the battery switch to decouple the camera components from the power supply if no enable signal is provided on the coaxial cable.

FIG. 3B illustrates an ECU (or other domain controller) operable to provide the enable signal to the camera over the coaxial cable. The ECU may be any central processing unit for the vehicle's sensing system, or it may be a dedicated controller for managing multiple cameras or sensors. The term domain controller refers to any centralized control unit that manages a specific set of functions within the vehicle, such as advanced driver-assistance systems (ADAS) or infotainment. The domain controller may include multiple ECUs, or the terms could be considered synonymous in certain architectures. Additionally or alternatively, the ECU may be connected to the camera via the GMSL. In some examples, the PoC filter of the ECU may filter out high frequency signals associated with SERDES data as well as reverse channel data. The SERDES data may include image data from the camera, control signals, or other information necessary for the operation of the sensing system. The reverse channel data may include control signals or feedback from the camera to the ECU, such as status information or acknowledgments. The PoC filter is designed to isolate the DC enable signal from these high-frequency components, ensuring reliable delivery of the enable signal. Accordingly, the PoC filter passes only a low frequency signal associated with the enable signal. Low frequency may refer to frequencies significantly below the operating frequency of the SERDES interface, such as frequencies below 1 kHz, below 10 kHz, or below 100 kHz, depending on the specific implementation. The specific cutoff frequency of the PoC filter may be based on the SERDES data rate and the desired level of signal separation. The PoC filter may also ensure that the enable signal is a low current signal in order to minimize power consumption. A decoupling capacitor may filter out low frequency signals, such that the capacitor passes only high frequency SERDES data to the deserializer.

The ECU may provide the enable signal to the camera by applying a static DC voltage to the coaxial cable. A switch enabled by a microcontroller output (or microprocessor or integrated circuit) of the ECU connects the power supply (e.g., the main power supply, or vehicle battery) of the ECU to the coaxial cable, providing a static DC voltage enable signal to the camera, as discussed above. In some examples, a short-circuit protection device (e.g., a resettable fuse) may be included between the switch and the PoC filter. Alternatively, line fault monitoring (e.g., a serial resistor) may disable the enable voltage if a short occurs. Optionally, an additional small power supply may be used to provide the enable signal in lieu of the ECU power supply or other existing power supplies. This additional power supply may be a separate DC-DC converter or a low-power voltage regulator that is dedicated to providing the enable signal. This can be useful in situations where the main ECU power supply is noisy or has limited current capacity. Using a separate power supply may improve signal integrity. Optionally, LFM may be used to ensure the camera is disabled if communication is lost between the camera and the ECU. For example, a pull-up resistor and a multiplexor may provide the microcontroller with an LFM input. A pull-up resistor is a resistor connected between a signal line and a positive voltage source, ensuring that the signal line is at a high logic level when no other input is present. A multiplexer (or mux) is a device that selects one of several input signals and forwards the selected input to a single output. In this context, it is selecting the LFM voltage and providing it as an input to the microcontroller. Alternatively, the pull-up resistor may provide LFM input to the microcontroller directly. Accordingly, the microcontroller may decouple the power supply from the coaxial cable via the switch if the ECU has a fault or fails to disable the camera. This provides a fail-safe mechanism to ensure that the camera is disabled if communication is lost or if the ECU is unable to control the enable signal.

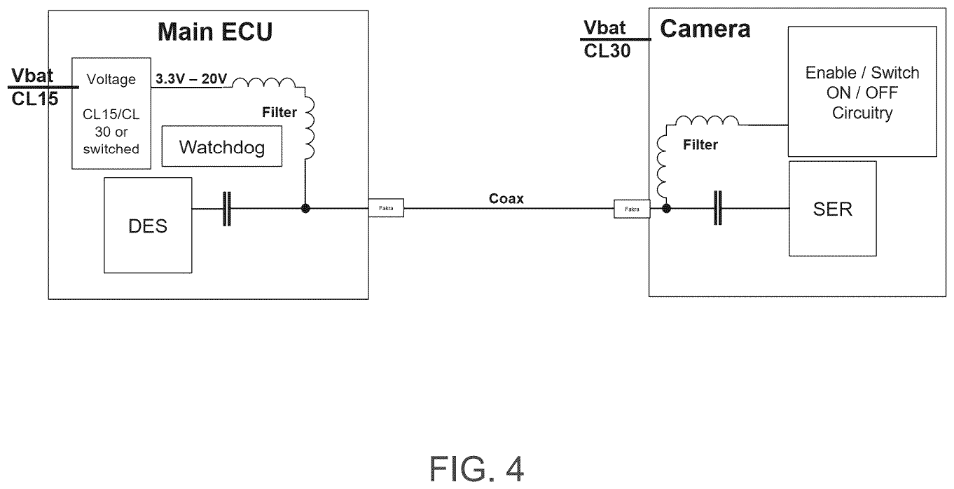

In FIG. 4, an ECU is connected to a camera via a coaxial cable. The camera is powered via a connection to the vehicle battery, such as a direct Vbatt connection, a clamp 15 connection, or a clamp 30 connection, and thus is not using power over coaxial. The ECU may provide an enable signal to the camera over the coaxial cable using a simple filter and a connection to a voltage supply. Here, the filter includes one or more inductors and capacitors. The capacitor may block DC signals (i.e., the enable signal) while allowing high frequency data, such as SERDES data or data from a GMSL, to pass. Similarly, the inductors block high frequency data (e.g., image data, camera control data, etc.) while allowing the enable signal to pass. The camera similarly includes a simple filter of inductors and/or capacitors to filter the high frequency data passed over the coaxial cable from the separate enable signal. This filter at the camera may be a Power over Coaxial (PoC) filter, even though power is not being supplied over the coaxial cable in this configuration. The PoC filter's function in this example is to separate the DC enable signal from the high-frequency data signals. The enable signal is provided to enable circuitry of the camera. For example, when the enable signal is disabled (e.g., a low signal is passed via the coaxial cable), the enable circuitry may disconnect the camera from the battery, thus disabling the camera. Conversely, when the enable signal is enabled (e.g., a high signal is passed via the coaxial cable), the enable circuitry may connect the camera to the battery, thus enabling the camera.

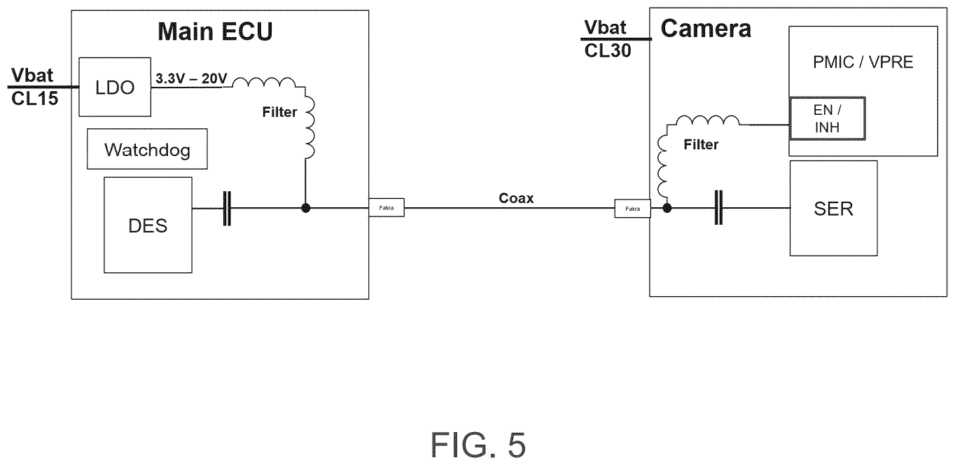

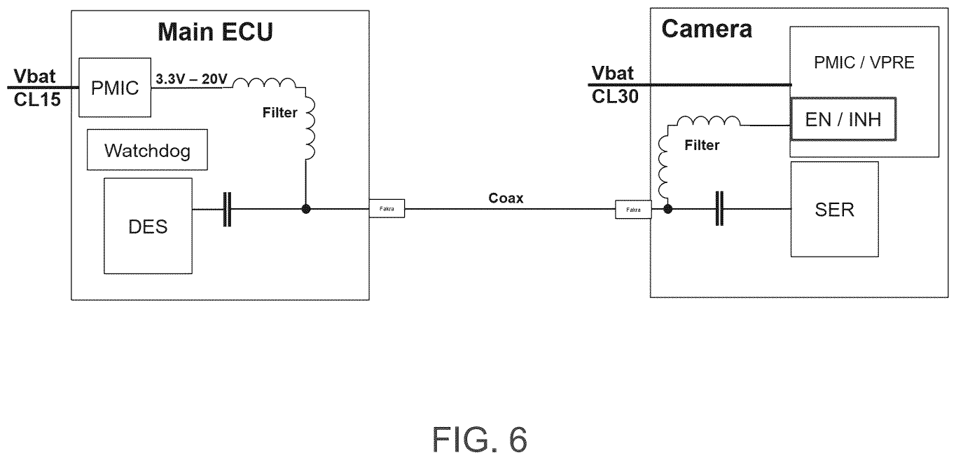

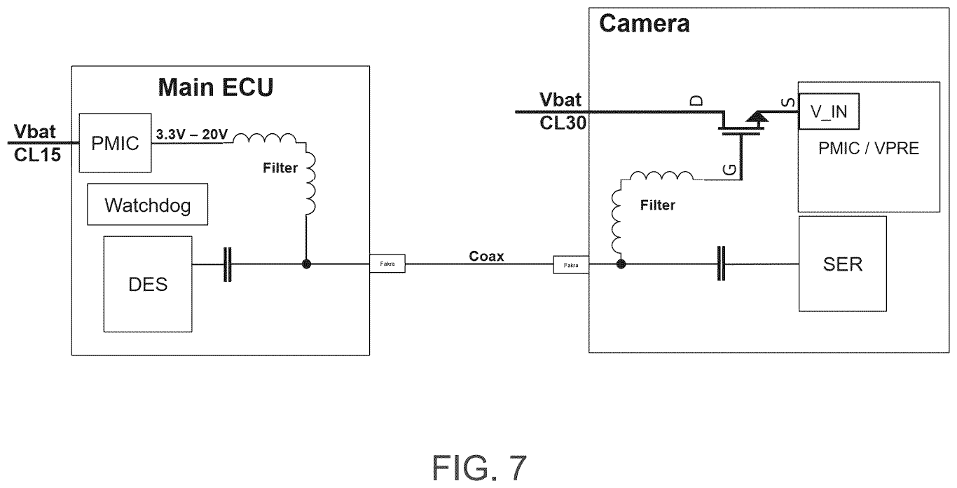

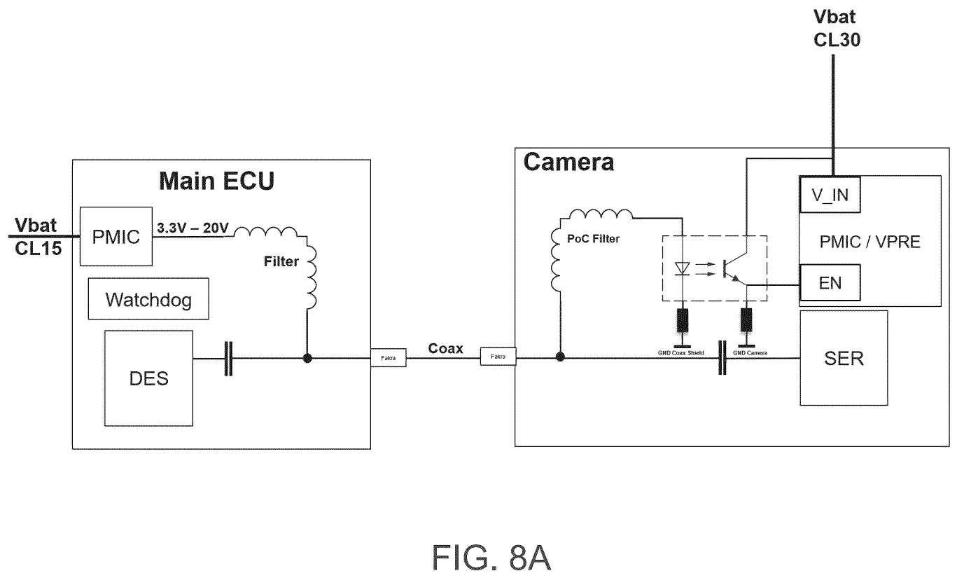

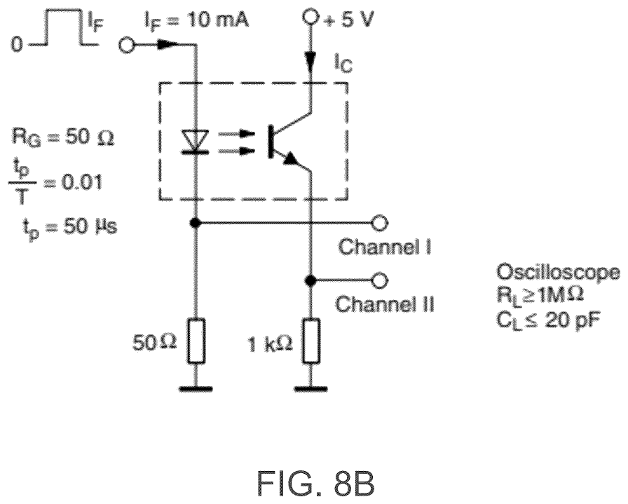

FIG. 5 illustrates a similar setup to FIG. 4, but instead the ECU connects the enable signal to an LDO regulator and the camera's enable circuitry is maintained by PMIC. FIG. 6 illustrates another implementation where the ECU includes a PMIC circuit for driving the enable signal. Here, the PMIC of the camera is directly connected to the vehicle battery. FIG. 7 illustrates an implementation where the camera incorporates a switch (e.g., a MOSFET switch or other transistor) between the battery and the PMIC with the enable signal from the coaxial cable selecting the switch (e.g., via a connection to the gate of a MOSFET). FIG. 8A illustrates an implementation with galvanic isolation or insulation. FIG. 8B illustrates a test circuit for saturated operation of this implementation.

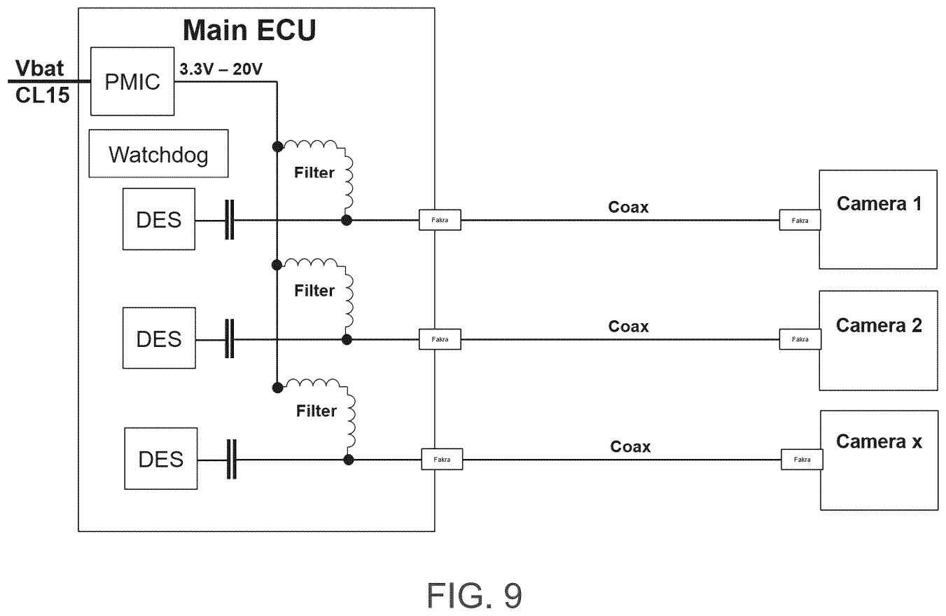

As shown in FIG. 9, in some examples, the ECU may transmit the enable signal to multiple cameras or other sensors simultaneously and in parallel. In FIG. 9, each camera is connected to the ECU via a separate coaxial cable, and the same enable signal (provided by the PMIC) is passed via each coaxial cable to each camera. This configuration allows for synchronized activation or deactivation of multiple sensors, which can be beneficial in applications such as surround-view systems, where simultaneous image capture from multiple viewpoints is desired. The enable signal, in this parallel configuration, may be a DC offset voltage, as described previously, superimposed on the high-speed data stream of each coaxial cable. The amplitude and duration of the enable signal can be consistent across all connected cameras, ensuring uniform behavior. Each camera may be powered by a connection to the battery of the vehicle (i.e., not via the cable).

In other examples, the ECU generates a separate enable signal for each camera such that one or more cameras may be enabled while one or more other cameras may be disabled. This selective enablement provides flexibility in managing power consumption and system functionality. For instance, in a parking assist system, only the rearward-facing cameras might be activated during a reversing maneuver, while the forward-facing cameras remain in a low-power or sleep state. Similarly, during highway driving, only forward-facing cameras and sensors may be enabled. The selective enablement may be based on driver input, sensor data (e.g., object detection), or other vehicle operating conditions (e.g., selecting reverse gear). The PMIC may include a separate output for each camera that controls the enable signal for that particular camera.

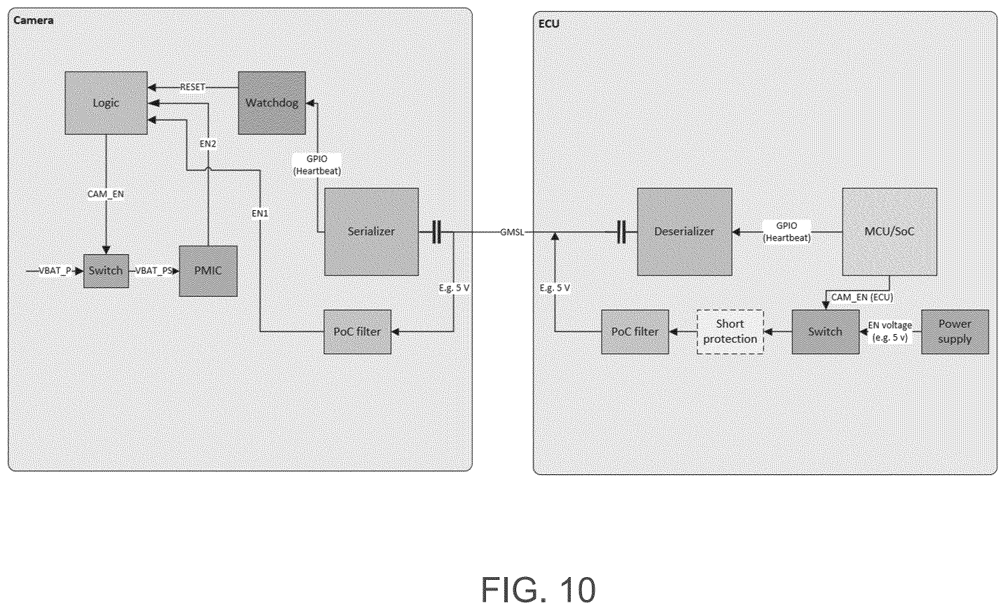

Referring now to FIG. 10, in other implementations, the SERDES may include LFM such that a short-duration signal (i.e., a short signal or a short enable signal) (e.g., a pulse, a square wave, a rectangular wave, etc.) may be used to enable the camera. The short-duration signal may be distinguished from a static or DC enable signal in that the short-duration signal has a defined, limited duration, whereas the static or DC enable signal maintains a substantially constant voltage level for the entire duration that the camera is to remain enabled. The use of a short-duration signal can offer advantages in terms of power efficiency and system responsiveness. As with implementations above, the ECU may provide the short enable signal to the camera. To provide the short enable signal, the ECU may include a microcontroller (or a microprocessor or system-on-a-chip (SoC)), a first PoC filter, and a switch that is operable to connect the power supply to the PoC filter. The microcontroller may be programmed to generate the short enable signal with specific parameters, such as pulse width, amplitude, and shape. The microcontroller may coordinate the timing of the short enable signal with other system operations, such as the initialization of the SERDES link.

Upon receiving input from the microcontroller, the switch may connect the power supply to the first PoC filter. In some examples, a short-circuit protection device may connect the switch to the first PoC filter. The first PoC filter then provides the short enable signal to the camera via the coaxial cable. Optionally, the ECU may provide the short enable signal via GMSL. In this case, the short enable signal may be superimposed on the GMSL data stream, and the GMSL deserializer at the camera may be configured to extract the short enable signal. This can be achieved by, for example, incorporating appropriate filtering and biasing circuitry within the serializer and deserializer. The short enable signal may comprise a short pulse. For example, the short enable signal may have a duration of less than one second (0.5 seconds, 0.2 seconds, 0.1 seconds, etc.), one second, two seconds, five seconds, etc. The duration of the short enable signal may be selected to be long enough to reliably trigger the enable circuitry in the camera, but short enough to minimize power consumption and avoid interference with the SERDES communication. The optimal duration may depend on the characteristics of the camera's enable circuitry and the overall system design. The short enable signal may have an amplitude of any number of volts, such as one volt, two volts, five volts, etc.

The camera may include a second PoC filter, a logic circuit (e.g., a circuit including logic gates), a watchdog circuit, a PMIC, and/or a switch that is operable to couple the power supply to the PMIC. The second PoC filter receives the short enable signal via the coaxial cable and provides the short enable signal to the logic circuit. Upon receiving the short enable signal, the logic circuit connects the power supply to the camera. Specifically, the logic circuit, after receiving the short enable signal from the ECU, provides a second enable signal to the switch. Upon receiving the short enable signal, the switch couples the power supply to the PMIC. The PMIC may provide a third enable signal to the logic circuit once the switch has coupled the battery to the PMIC, such that the camera remains in the enabled state after the ECU short enable signal ceases.

The LFM monitors the connection between the ECU and the camera after the short enable signal from the ECU ceases. The microcontroller of the ECU provides a heartbeat signal via the coaxial cable. For example, the heartbeat signal may be included in the SERDES data (e.g., SERDES general purpose input/output (GPIO)) provided between the ECU and the camera. The watchdog circuit of the camera receives the heartbeat to monitor the status of the ECU. The watchdog circuit may provide a reset signal to the logic circuit if the connection between the ECU and the camera is lost or the ECU has a fault. Thus, the logic circuit disables the camera if the watchdog does not detect the heartbeat signal.

While examples herein discuss an ECU enabling or disabling a camera, the implementations are applicable to any sensor or system that is connected to an ECU (or other processor) via a coaxial cable. For example, the ECU may enable/disable radar sensors, LIDAR sensors, ultrasonic sensors, etc. The ECU may enable or disable any number of other systems, such as an in-vehicle infotainment (IVI) system, rearview cameras, surround view systems, advanced driving assistance systems (ADAS), digital instrument clusters, head-up displays, in-car cameras, telematics systems, adaptive lighting systems, other ECUs (e.g., high-speed data transmissions between ECUs) or any other remote sensor/system that the ECU communicates with via a cable (e.g., a coaxial cable). More generally, the implementations described herein can be applied to any remote device that receives both power and data/control signals, where power is provided independently of the data/control signals, and where there is a desire to remotely control the power state (e.g., on, off, sleep, standby) of the remote device.

Thus, implementations herein are directed to a remote ECU, camera, or other device that does not include a dedicated microcontroller and is connected to a main ECU via a communication interface, such as a serializer/deserializer interface, and a vehicle battery. The remote ECU is configured to meet sleep current requirements (e.g., typically less than 100 μA). While the SERDES remains operable, the remote ECU maintains a current draw below the maximum sleep current threshold. This can be achieved without the need to add further intelligence or components to the remote ECU by using the disclosed concepts, which extract an enable signal from the communication interface.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or pixels or at least three million photosensor elements or pixels or at least five million photosensor elements or pixels arranged in rows and columns. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The system may utilize sensors, such as radar sensors or imaging radar sensors or lidar sensors or the like, to detect presence of and/or range to objects and/or other vehicles and/or pedestrians. The sensing system may utilize aspects of the systems described in U.S. Pat. Nos. 10,866,306; 9,954,955; 9,869,762; 9,753,121; 9,689,967; 9,599,702; 9,575,160; 9,146,898; 9,036,026; 8,027,029; 8,013,780; 7,408,627; 7,405,812; 7,379,163; 7,379,100; 7,375,803; 7,352,454; 7,340,077; 7,321,111; 7,310,431; 7,283,213; 7,212,663; 7,203,356; 7,176,438; 7,157,685; 7,053,357; 6,919,549; 6,906,793; 6,876,775; 6,710,770; 6,690,354; 6,678,039; 6,674,895 and/or 6,587,186, and/or U.S. Publication Nos. US-2019-0339382; US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The radar sensors of the sensing system each comprise a plurality of transmitters that transmit radio signals via a plurality of antennas, a plurality of receivers that receive radio signals via the plurality of antennas, with the received radio signals being transmitted radio signals that are reflected from an object present in the field of sensing of the respective radar sensor. The system includes an ECU or control that includes a data processor for processing sensor data captured by the radar sensors. The ECU or sensing system may be part of a driving assist system of the vehicle, with the driving assist system controlling at least one function or feature of the vehicle (such as to provide autonomous driving control of the vehicle) responsive to processing of the data captured by the radar sensors.

The radar sensor or sensors may be disposed at the vehicle so as to sense exterior of the vehicle. For example, the radar sensor may comprise a front sensing radar sensor mounted at a grille or front bumper of the vehicle, such as for use with an automatic emergency braking system of the vehicle, an adaptive cruise control system of the vehicle, a collision avoidance system of the vehicle, etc., or the radar sensor may be comprise a corner radar sensor disposed at a front corner or rear corner of the vehicle, such as for use with a surround vision system of the vehicle, or the radar sensor may comprise a blind spot monitoring radars disposed at a rear fender of the vehicle for monitoring sideward/rearward of the vehicle for a blind spot monitoring and alert system of the vehicle. Optionally, the radar sensor or sensors may be disposed within the vehicle so as to sense interior of the vehicle, such as for use with a cabin monitoring system of the vehicle or a driver monitoring system of the vehicle or an occupant detection or monitoring system of the vehicle. The radar sensing system may comprise multiple input multiple output (MIMO) radar sensors having multiple transmitting antennas and multiple receiving antennas.

The system may utilize aspects of driver monitoring systems and/or head and face direction and position tracking systems and/or eye tracking systems and/or gesture recognition systems. Such head and face direction and/or position tracking systems and/or eye tracking systems and/or gesture recognition systems may utilize aspects of the systems described in U.S. Pat. Nos. 11,827,153; 11,780,372; 11,639,134; 11,582,425; 11,518,401; 10,958,830; 10,065,574; 10,017,114; 9,405,120 and/or 7,914,187, and/or U.S. Publication Nos. US-2024-0383406; US-2024-0190456; US-2024-0168355; US-2022-0377219; US-2022-0254132; US-2022-0242438; US-2021-0323473; US-2021-0291739; US-2020-0320320; US-2020-0202151; US-2020-0143560; US-2019-0210615; US-2018-0231976; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or U.S. provisional application Ser. No. 63/673,225, filed Jul. 19, 2024, and/or U.S. provisional application Ser. No. 63/641,574, filed May 2, 2024, and/or International Publication No. WO 2023/220222, which are all hereby incorporated herein by reference in their entireties.

Optionally, the driver monitoring system may be integrated with a camera monitoring system (CMS) of the vehicle. The integrated vehicle system incorporates multiple inputs, such as from the inward viewing or driver monitoring camera and from the forward-viewing camera, as well as from a rearward-viewing camera and sideward-viewing cameras of the CMS (e.g., a rearward-viewing camera disposed at the rear of the vehicle remote from the rear backup camera of the vehicle, and rearward-viewing cameras disposed at respective sides of the vehicle, such as at respective side-mounted exterior rearview mirror assemblies of the vehicle), to provide the driver with unique collision mitigation capabilities based on full vehicle environment and driver awareness state. The rearward viewing camera may comprise a rear backup camera of the vehicle or may comprise a centrally located higher mounted camera (such as at a center high-mounted stop lamp (CHMSL) of the vehicle), whereby the rearward viewing camera may view rearward and downward toward the ground at and rearward of the vehicle. The image processing and detections and determinations are performed locally within the interior rearview mirror assembly and/or the overhead console region, depending on available space and electrical connections for the particular vehicle application. The CMS cameras and system may utilize aspects of the systems described in U.S. Publication Nos. US-2021-0245662; US-2021-0162926; US-2021-0155167; US-2018-0134217 and/or US-2014-0285666, and/or International Publication No. WO 2022/150826, which are all hereby incorporated herein by reference in their entireties.

The ECU may receive image data captured by a plurality of cameras of the vehicle, such as by a plurality of surround view system (SVS) cameras and a plurality of camera monitoring system (CMS) cameras and optionally one or more driver monitoring system (DMS) cameras. The ECU may comprise a central or single ECU that processes image data captured by the cameras for a plurality of driving assist functions and may provide display of different video images to a video display screen in the vehicle (such as at an interior rearview mirror assembly or at a central console or the like) for viewing by a driver of the vehicle. The system may utilize aspects of the systems described in U.S. Pat. Nos. 10,442,360 and/or 10,046,706, and/or U.S. Publication Nos. US-2021-0245662; US-2021-0162926; US-2021-0155167 and/or US-2019-0118717, and/or International Publication No. WO 2022/150826, which are all hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular sensing system, the vehicular sensing system comprising:
a sensor disposed at a vehicle equipped with the vehicular sensing system and sensing exterior of the equipped vehicle, wherein the sensor is operable to capture sensor data;
an electronic control unit (ECU) comprising electronic circuitry and associated software;
wherein the electronic circuitry of the ECU comprises a data processor operable to process sensor data captured by the sensor and transferred to the ECU;
wherein the sensor connects with the ECU via a cable;
wherein the sensor is electrically powered by a power source, and wherein electrical power from the power source is not provided to the sensor via the cable;
wherein the ECU is operable to provide an enable signal that is carried to the sensor via the cable, and wherein the enable signal enables operation of the sensor; and
wherein, responsive to the sensor receiving the enable signal from the ECU via the cable, the sensor operates to capture sensor data and sensor data captured by the sensor is transferred to the ECU via the cable.

2. The vehicular sensing system of claim 1, wherein the cable comprises a coaxial cable.

3. The vehicular sensing system of claim 1, wherein the sensor is electrically powered by the power source responsive to receiving the enable signal.

4. The vehicular sensing system of claim 1, wherein the sensor comprises filtering components to filter the enable signal from the sensor data.

5. The vehicular sensing system of claim 4, wherein the filtering components comprise (i) at least one inductor and (ii) at least one capacitor.

6. The vehicular sensing system of claim 1, wherein the power source comprises a battery of the equipped vehicle.

7. The vehicular sensing system of claim 1, wherein the sensor comprises a power management integrated circuit (PMIC).

8. The vehicular sensing system of claim 1, wherein the sensor comprises an electronic switch, and wherein the enable signal controls the electronic switch.

9. The vehicular sensing system of claim 8, wherein the electronic switch comprises a MOSFET.

10. The vehicular sensing system of claim 1, wherein the sensor is isolated from the ECU via galvanic isolation.

11. The vehicular sensing system of claim 1, comprising a plurality of sensors, wherein each respective sensor of the plurality of sensors connects with the ECU via a respective cable, and wherein the ECU is operable to provide a respective enable signal that is carried to the respective sensor via each respective cable.

12. The vehicular sensing system of claim 1, wherein the sensor comprises a camera.

13. The vehicular sensing system of claim 1, wherein the sensor comprises a radar sensor.

14. The vehicular sensing system of claim 1, wherein the enable signal comprises a DC offset voltage that enables operation of the sensor.

15. The vehicular sensing system of claim 1, wherein the enable signal comprises a static DC offset voltage.

16. The vehicular sensing system of claim 15, wherein the static DC offset voltage comprises a first DC voltage, and wherein the ECU is operable to provide a disable signal that is carried to the sensor via the cable, and wherein the disable signal comprises a second DC offset voltage comprising a second DC voltage different from the first DC voltage, and wherein, responsive to the sensor receiving the disable signal, the sensor stops operating to capture sensor data.

17. The vehicular sensing system of claim 16, wherein the second DC voltage is zero volts.

18. The vehicular sensing system of claim 1, wherein the enable signal comprises a pulsed signal.

19. The vehicular sensing system of claim 18, wherein the sensor comprises a watchdog circuit, and wherein the ECU provides a heartbeat signal to the sensor via the cable, and wherein the watchdog circuit monitors the heartbeat signal, and wherein the sensor, responsive to the watchdog circuit monitoring the heartbeat signal, stops operating to capture sensor data.

20. A vehicular sensing system, the vehicular sensing system comprising:
a sensor disposed at a vehicle equipped with the vehicular sensing system and sensing exterior of the equipped vehicle, wherein the sensor is operable to capture sensor data;
an electronic control unit (ECU) comprising electronic circuitry and associated software;
wherein the electronic circuitry of the ECU comprises a data processor operable to process sensor data captured by the sensor and transferred to the ECU;
wherein the sensor connects with the ECU via a coaxial cable;
wherein the sensor is electrically powered by a power source, and wherein electrical power from the power source is not provided to the sensor via the coaxial cable;
wherein the ECU is operable to provide an enable signal that is carried to the sensor via the coaxial cable, and wherein the enable signal comprises a DC offset voltage that enables operation of the sensor; and
wherein, responsive to the sensor receiving the enable signal from the ECU via the coaxial cable, the sensor operates to capture sensor data and sensor data captured by the sensor is transferred to the ECU via the coaxial cable.

21. The vehicular sensing system of claim 20, wherein the sensor is electrically powered by the power source responsive to receiving the enable signal.

22. The vehicular sensing system of claim 20, wherein the power source comprises a battery of the equipped vehicle.

23. The vehicular sensing system of claim 20, wherein the sensor is isolated from the ECU via galvanic isolation.

24. A vehicular sensing system, the vehicular sensing system comprising:
a camera disposed at a vehicle equipped with the vehicular sensing system and sensing exterior of the equipped vehicle, wherein the camera is operable to capture image data;
an electronic control unit (ECU) comprising electronic circuitry and associated software;
wherein the electronic circuitry of the ECU comprises a data processor operable to process image data captured by the camera and transferred to the ECU;
wherein the camera connects with the ECU via a cable;
wherein the camera is electrically powered by a power source, and wherein electrical power from the power source is not provided to the camera via the cable;
wherein the ECU is operable to provide an enable signal that is carried to the camera via the cable, and wherein the enable signal comprises a DC offset voltage that enables operation of the camera; and
wherein, responsive to the camera receiving the enable signal from the ECU via the cable, the camera operates to capture image data and image data captured by the camera is transferred to the ECU via the cable.

25. The vehicular sensing system of claim 24, wherein the enable signal comprises a static DC offset voltage.

26. The vehicular sensing system of claim 25, wherein the static DC offset voltage comprises a first DC voltage, and wherein the ECU is operable to provide a disable signal that is carried to the camera via the cable, and wherein the disable signal comprises a second DC offset voltage comprising a second DC voltage different from the first DC voltage, and wherein, responsive to the camera receiving the disable signal, the camera stops operating to capture image data.

27. The vehicular sensing system of claim 26, wherein the second DC voltage is zero volts.
